(19) United States
(12) Patent Application Publication
(10) Pub. No.: US 2025/0216664 A1
(43) Pub. Date: Jul. 3, 2025

(54) SYSTEMS AND METHODS FOR HEATING A BIOLOGICAL CARTRIDGE IN A MICROSCOPE ASSEMBLY

(71) Applicant: IDEXX Laboratories, Inc., Westbrook, ME (US)

(72) Inventors: Caleb Sheehan Niles, Portland, ME (US); Spencer Franklin McElwain, Saco, ME (US)

(73) Assignee: IDEXX Laboratories, Inc., Westbrook, ME (US)

(21) Appl. No.: 19/001,670

(22) Filed: Dec. 26, 2024

Related U.S. Application Data
(60) Provisional application No. 63/615,440, filed on Dec. 28, 2023.

(51) Int. Cl. G02B 21/30; G01N 1/44; G02B 21/26; G02B 21/36

(52) U.S. Cl. CPC G02B 21/30; G01N 1/44; G02B 21/26; G02B 21/36

(57) ABSTRACT

The present disclosure is directed to assemblies and methods for heating a biological cartridge in a microscope assembly. The assembly includes a stage for receiving a cartridge holding a biological sample, the cartridge having a top face, a bottom face, and defining a sample chamber that at least partially encapsulates the biological sample, an image detector in optical communication with the stage, a controller communicatively coupled to the image detector, and a heating element communicatively coupled to the controller, wherein the heating element defines a perimeter surrounding a sample chamber of the cartridge with the cartridge positioned on the stage.

### CROSS-REFERENCE TO RELATED APPLICATION

This application claims the benefit of co-pending U.S. Provisional Patent Application No. 63/615,440, filed Dec. 28, 2023, for “Systems And Methods For Heating A Biological Cartridge In A Microscope Assembly,” which is hereby incorporated by reference in its entirety including the drawings.

### FIELD

The present disclosure relates to systems and methods for heating a biological cartridge in a microscope assembly.

### TECHNICAL BACKGROUND

Microscope assemblies, such as digital microscope assemblies, may capture images and other data associated with biological samples. Some parameters of biological samples may vary with temperature. To ensure consistency of images and data generated by a microscope assembly of a biological sample, a biological sample may be heated. Conventional biological sample heaters may not evenly distribute heat across the entire sample, which may cause inconsistent results from the microscope assembly.

### SUMMARY

Biological samples may be analyzed by a microscope assembly, such as a digital microscope assembly. It is desirable for microscope assemblies to generate consistent results when analyzing biological samples. However, various parameters of a biological sample may change as the temperature of the sample changes. By maintaining the biological sample within a fixed temperature range, more consistent results may be obtained. Therefore, a need exists for systems and methods for heating a biological cartridge in a microscope assembly.

The present system and method can maintain a biological sample within a predetermined temperature range to generate more consistent results when the biological sample within the biological cartridge is analyzed by the microscope assembly.

In embodiments, the system generally includes a microscope assembly. The microscope assembly includes an image detector communicatively coupled to a controller. The microscope assembly includes a stage which is arranged to receive a biological cartridge. The biological cartridge includes a sample chamber that at least partially encapsulates the biological sample. A heating element is communicatively coupled to the controller and surrounds the sample chamber of the biological cartridge.

According to one embodiment, an assembly includes a stage for receiving a biological cartridge holding a biological sample, the biological cartridge having a top face, a bottom face, and defining a sample chamber that at least partially encapsulates the biological sample, an image detector in optical communication with the stage, a controller communicatively coupled to the image detector, and a heating element communicatively coupled to the controller, wherein the heating element defines a perimeter surrounding a sample chamber of the biological cartridge with the biological cartridge positioned on the stage.

According to another embodiment a method includes contacting a heat spreader of the microscope assembly with a biological cartridge containing a biological sample, the biological cartridge directly contacting the heat spreader and the heat spreader directly contacting a heating element, applying, by the heating element, heat to the biological cartridge, measuring a temperature of the heating clement with a temperature sensor, automatically adjusting the heating clement in response to the measured temperature, and taking an image of the biological sample.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of the present disclosure may be better understood when read in conjunction with the following drawings in which:

FIG. 1 schematically depicts a digital microscope assembly with a biological cartridge according to one or more embodiments shown and described herein;

FIG. 2 schematically depicts the digital microscope assembly of FIG. 1 without the biological cartridge, according to one or more embodiments shown and described herein;

FIG. 3 schematically depicts a heating element and a heat spreader of the digital microscope assembly of FIG. 1, according to one or more embodiments shown and described herein;

FIG. 4 schematically depicts a stage of the microscope assembly of FIG. 1, according to one or more embodiments shown and described herein;

FIG. 5 schematically depicts the stage of the microscope assembly of FIG. 1, the heat spreader, and the heating element, according to one or more embodiments shown and described herein;

FIG. 6 schematically depicts the stage of the microscope assembly of FIG. 1, a biological cartridge, the heat spreader, and the heating element according to one or more embodiments shown and described herein; and

FIG. 7 schematically depicts a flowchart of a method of operating the microscope assembly of FIG. 1, according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

Embodiments of the present disclosure are directed to methods and systems for heating a biological cartridge in a digital microscope assembly. In embodiments, the system includes a microscope assembly. The microscope assembly may include a controller, an image detector, a stage, a heating element, and a heat spreader. The microscope assembly may be configured to hold a biological cartridge, which has a biological sample captured therein. The microscope assembly may be further configured to analyze the biological sample captured within the biological cartridge. The microscope assembly may be configured to maintain the biological sample within a predetermined temperature range.

Conventional microscope assemblies may not maintain biological samples within fixed temperature ranges. This may cause variation in the data gathered from the biological samples, as certain attributes of biologic samples may vary with temperature. The present system can maintain the biological sample within a predetermined temperature range to produce more consistent results with the microscope assembly.

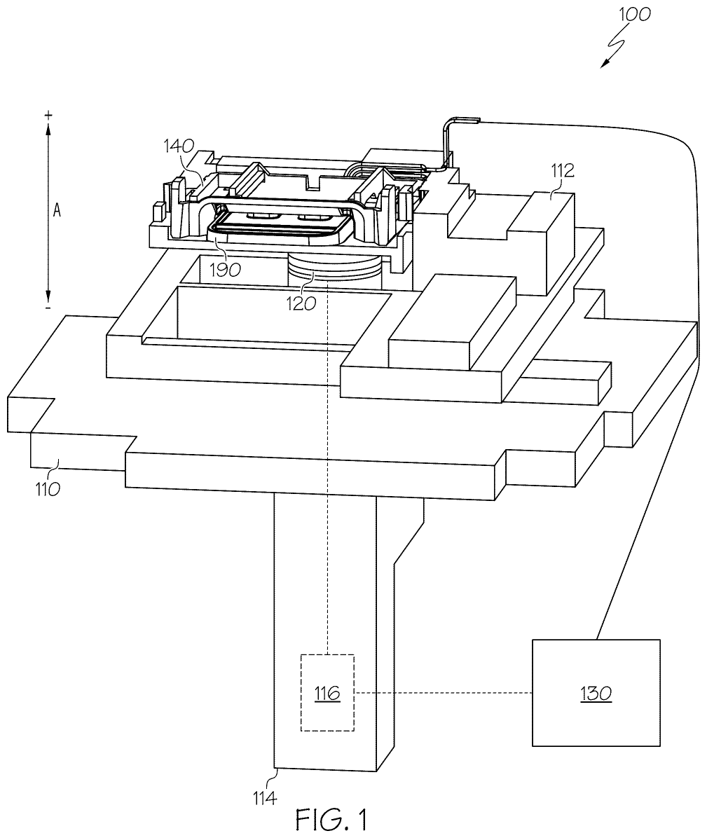

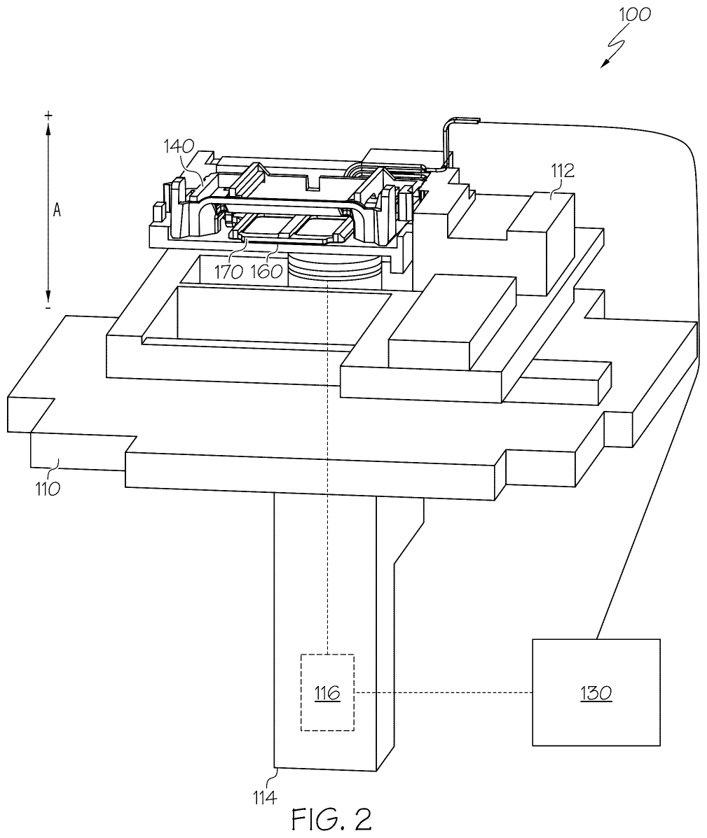

Referring now to FIGS. 1 and 2, an example microscope assembly 100 is shown. The microscope assembly 100 includes a microscope base 110. The microscope base 110 may include a top side 112 and a bottom side 114. The top side 112 may face towards the positive side of axis A, and the bottom side 114 may face towards the negative side of axis A. The microscope base 110 may be made of any suitable material, such as a metal or a plastic, and may provide a structure for other elements of the microscope assembly 100 to be coupled to, as will be described in more detail herein.

The microscope assembly 100 includes a controller 130. The controller 130 may be a computing device configured to control various elements of the microscope assembly 100, as will be described in more detail herein. In embodiments, the controller 130 may be any suitable computing device, including but not limited to a programmable logic controller, a proportional controller, an integral controller, a derivative controller, or any other suitable type of controller. The controller 130 may include a central processor.

The microscope assembly 100 includes an image detector 116, which may be housed within the microscope base 110 and is shown in phantom. The image detector 116 may be a digital camera, a photodiode, a charge-coupled device, or any other suitable type of image detector. The image detector 116 is communicatively coupled to the controller 130. The image detector may be used to capture images and/or data of a biological sample, as will be described in more detail herein. The image detector 116 may be coupled to an objective lens 120, which may be positioned so as to view a biological cartridge 190, as will be described in more detail herein.

The microscope assembly 100 includes a stage 140. The stage 140 is coupled to the microscope base 110 at the top side 112 of the microscope base 110. The stage 140 may be configured to secure other elements to the microscope assembly 100, as will be described in more detail herein.

The microscope assembly 100 is configured to hold the biological cartridge 190. The biological cartridge 190 is configured to at least partially encapsulate a biological sample for imaging by the microscope assembly 100, as will be described in more detail herein. Biological samples, in embodiments described herein can include any biological material for interrogation, such as and without limitation, a blood sample, a fine needle aspirate sample, an ear swab sample, or the like.

In embodiments, the microscope assembly 100 includes a heat spreader 170. The heat spreader 170 distributes heat to the biological cartridge 190, as will be described in more detail herein.

The microscope assembly 100 includes a heating element 160. The heating element 160 may be configured to apply heat to the biological cartridge 190, as will be described in more detail herein.

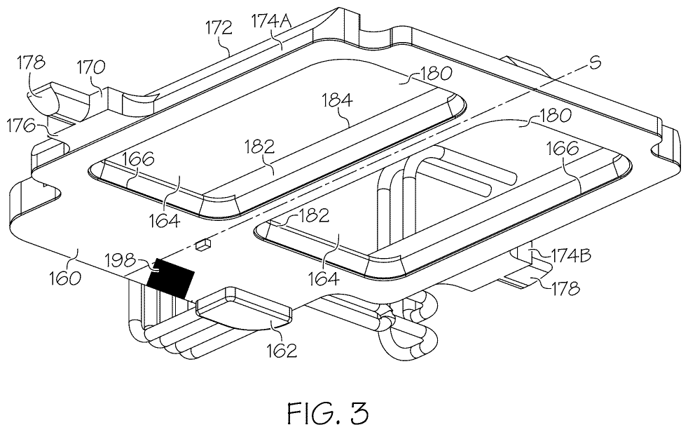

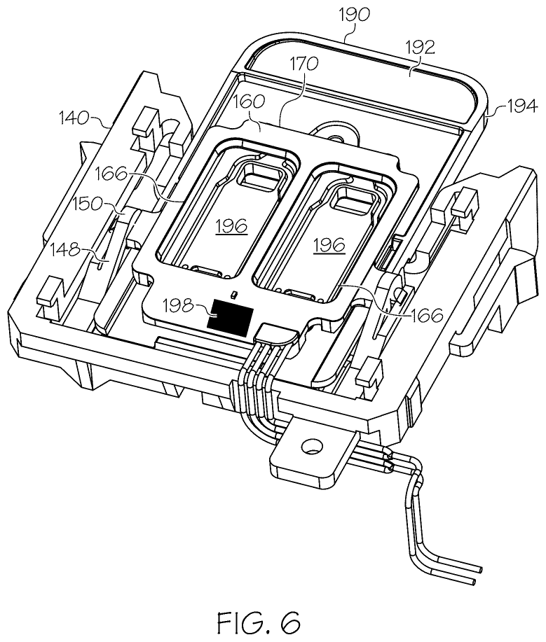

Referring now to FIG. 3, an illustration of the heating element 160 and the heat spreader 170 is shown consistent with a disclosed embodiment. In embodiments, the heat spreader 170 includes a top face 172, a pair of opposing side faces 174A and 174B, and a bottom face 176. The top face 172 may be structurally configured to contact a bottom face 194 (FIG. 6) of the biological cartridge 190, as will be shown and described in more detail herein. Each of the pair of opposing side faces 174A and 174B may include a mounting tab 178.

The mounting tabs 178 may be shaped and sized to fit into one or more mounting hooks 150 of the stage 140, as will be shown and described in more detail herein. While two mounting tabs 178 are shown, it should be understood that the heat spreader 170 may include any suitable number of mounting tabs 178, including but not limited to one mounting tab 178, three mounting tabs 178, five mounting tabs 178, or any other suitable number of mounting tabs 178. In other embodiments, other mounting features may be used, including but not limited to mechanical fasteners, geometric fit, spring-loaded pins, or any other suitable mounting feature.

The heat spreader 170 defines one or more openings 180. As illustrated, the heat spreader 170 defines two openings 180, but it should be understood that in embodiments, the heat spreader 170 may define any suitable number of openings 180, such as one opening 180, three openings 180, five openings 180, or any other suitable number of openings 180.

Each of the openings 180 may include a sidewall 182. The sidewall 182 may extend between the top face 172 to the bottom face 176. In some embodiments, the sidewall 182 may be inwardly tapered moving from the top face 172 to the bottom face 176. That is, the opening 180 may have a larger surface area at the bottom face 176 than at the top face 172. By having a tapered shape from the top face 172 to the bottom face 176, the sidewalls 182 may allow for the image detector 116 to more accurately image the biological sample.

In some embodiments, the sidewall 182 may have any other suitable profile, including but not limited to being tapered from outward from the bottom face 176 to the top face 172 or having a straight profile from the top face 172 to the bottom face 176.

The heat spreader 170 may include a septum 184. The septum 184 may separate the openings 180 when the heat spreader 170 has a plurality of openings 180. While one septum 184 is shown, it should be understood that any suitable number of septums 184 may be used, such as two septums 184 when the heat spreader 170 has three openings 180, four septums 184 when the heat spreader 170 has five openings 180, or any other suitable number of septums 184.

The heat spreader 170 may include a septum axis S. As illustrated, the heat spreader 170 is symmetrical about the septum axis S. However, it should be understood that in further embodiments, the heat spreader 170 may not be symmetrical about the septum axis S, such as having openings 180 of different shapes and/or sizes.

The heat spreader 170 may be made of any suitable material for conducting thermal energy, including but not limited to metals such as aluminum. The heat spreader 170 transfers heat via conduction from the heating element 160 to the biological cartridge 190, which may help to maintain the temperature of the biological sample held within the biological cartridge 190. In some embodiments, the heat spreader 170 is anodized to prevent the cartridge 190 from scratching the heat spreader 170.

The heating element 160 may directly contact the bottom face 176 of the heat spreader 170 such that the heating element 160 and the heat spreader 170 are thermally coupled to one another. The heating element 160 may be any suitable type of heating element, including but not limited to a resistive heater, a Peltier module, an LED lighting array, a radiation heater, or any other suitable type of heating element. The heating element 160 may be shaped and sized to contour to the openings 180 of the heat spreader 170.

In embodiments, the heating element 160 defines one or more openings 164. As illustrated, the heating element 160 includes two openings 164, but it should be understood that in embodiments, the heating element 160 defines any suitable number of openings 164, such as one opening 164, three openings 164, five openings 164, or any other suitable number of openings 164. Each of the openings 164 are defined by a perimeter 166. The heating element 160 may have an equal number of perimeters 166 as it has openings 164.

In embodiments, the heating element 160 defines openings 164 and the heat spreader 170 defines openings 180 that correspond to a number of sample chambers 196 (FIG. 6) of the biological cartridge 190 (FIG. 6). Corresponding openings 164 of the heating element 160 and openings 180 of the heat spreader 170 are generally aligned so that the sample chambers 196 (FIG. 6) of the biological cartridge 190 (FIG. 6) can be viewed through the stage 140. Further, because the openings 164 of the heating element 160 and the corresponding openings 180 of the heat spreader 170 generally surround the sample chambers 196 (FIG. 6) of the biological cartridge 190 (FIG. 6), heat transferred from the heating element 160 to the sample chambers 196 via the heat spreader 170 may be more evenly distributed as compared to heating elements and heat spreaders that do not surround the sample chambers 196.

The heating element 160 may include a coupler 162, which may transmit power and/or signals to the heating element 160 from the controller 130 (not shown).

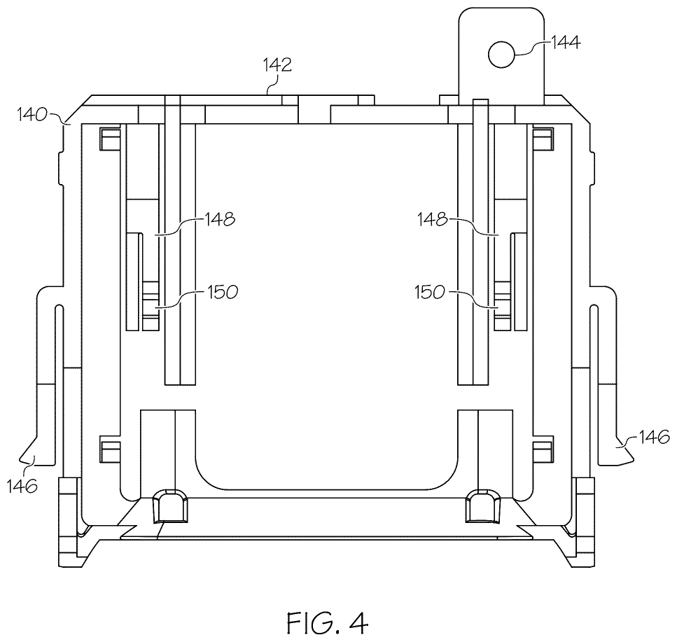

Referring now to FIG. 4, a top view of the stage 140 of the microscope assembly 100 is shown. In embodiments, the stage 140 includes a perimeter structure 142. The perimeter structure 142 may include various features for aligning and mounting the stage 140 relative to the microscope base 110 (illustrated and described above).

As illustrated, the perimeter structure 142 includes a mounting hole 144 and a plurality of locking projections 146 which may align and mount the stage 140 to the microscope base 110. However, it should be understood that in embodiments, other features may be used to align and mount the stage 140 relative to the microscope base 110, including but not limited to fasteners, springs and brackets, or any other suitable features.

The stage 140 includes/may include mounting arms 148. The mounting arms 148 may project inward from the perimeter structure 142. As illustrated, the stage 140 includes two mounting arms 148, but it should be understood that in embodiments, any suitable number of mounting arms 148 may be used, including but not limited to one mounting arm 148, four mounting arms 148, or any other suitable number of mounting arms 148. As illustrated, each of the mounting arms 148 are parallel to one another, but it should be understood that in embodiments, the mounting arms 148 may be arranged in any other suitable arrangement.

Each of the mounting arms 148 may include a mounting hook 150. The mounting hooks 150 may have a semi-circular shape and may be shaped and sized to accommodate the mounting tabs 178 of the heat spreader 170. The mounting arms 148 may deflect when the heat spreader 170 and the biological cartridge 190 are inserted into the stage 140. In embodiments, the mounting arms 148 apply pressure between the heat spreader 170 and the cartridge 190, which assists with heat transfer therebetween.

The stage 140 may be constructed of any suitable material, including but not limited to acetal homopolymer, acetal copolymer, nylon, polyethylene, polycarbonate, acrylonitrile butadiene styrene, or any other suitable material.

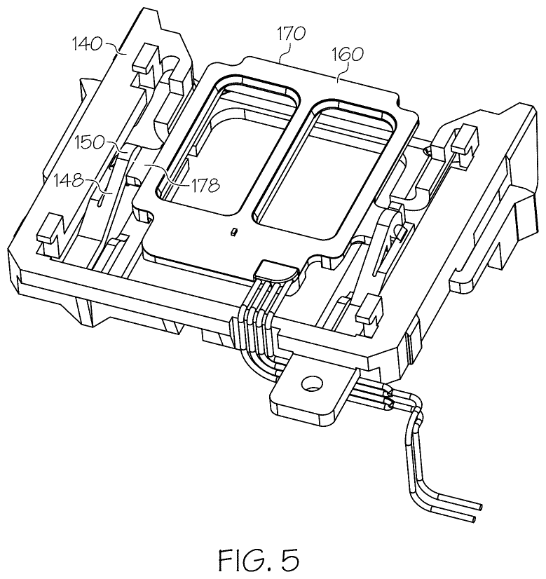

Referring now to FIG. 5, an illustration of the heat spreader 170 and heating element 160 coupled to the stage 140 is shown consistent with a disclosed embodiment. The mounting tabs 178 of the heat spreader 170 may be held within the mounting hooks 150 of the stage 140. The mounting tabs 178 may pivot about the mounting hooks 150. This may allow the heat spreader 170 and the attached heating element 160 to be leveled relative to the stage 140.

The mounting hooks 150 may apply a force to the heat spreader 170 relative to the stage 140. This may secure the heat spreader 170 and attached heating element 160 relative to the stage 140. However it should be understood that in other embodiments, other elements may be used to secure the heat spreader 170 relative to the stage 140, including but not limited to mechanical fasteners, geometric fit, spring-loaded pins, or any other suitable element.

It is noted that the mounting arms 148 are shown in their fully deflected position as illustrated in FIG. 5, however, the mounting arms 148 would be deflected less relative to the stage 140 when only the heat spreader 170 and heating element 160 are inserted therein without the biological cartridge 190. As illustrated in FIG. 5, the mounting arms 148 are shown in a deflected position as if the biological cartridge 190 is inserted therein.

Referring now to FIG. 6, an illustration of the biological cartridge 190, heat spreader 170, and heating element 160 coupled to the stage 140 is shown consistent with a disclosed embodiment. The biological cartridge 190 includes a top face 192, a bottom face 194, and at least one sample chamber 196. As illustrated, each of the at least one sample chambers 196 may protrude from the biological cartridge 190.

As illustrated, the biological cartridge 190 includes two sample chambers 196, but it should be understood that in embodiments, the biological cartridge 190 may include any suitable number of sample chambers 196, including but not limited to one sample chamber 196, three sample chambers 196, five sample chambers 196, or any other suitable number of sample chambers 196.

Each of the sample chambers 196 may at least partially encapsulate the biological sample. The biological sample may be, as a non-limiting example, a blood or tissue sample that is to be examined by the microscope assembly 100.

While each of the two sample chambers 196 are illustrated with the same depth, it should be understood that in embodiments, each of the sample chambers 196 may have different depths, such that a first sample chamber 196 has a shallow depth and a second sample chamber 196 has a deeper depth.

Each of the perimeters 166 of the heating element 160 may surround each of the sample chambers 196 of the biological cartridge 190.

The bottom face 194 of the biological cartridge 190 may be directly contacting the top face 172 of the heat spreader 170. The heat spreader 170 may distribute the heat provided from the heating element 160 to the biological cartridge 190, which may in turn heat the biological sample held inside of the biological cartridge 190. By heating the biological sample held inside of the biological cartridge 190, more consistent data may be generated by the microscope assembly 100 of the biological sample compared to microscope assemblies without a heating element.

A temperature sensor 198 may be attached to the heating element 160. The temperature sensor 198 may be communicatively coupled to the controller 130 (illustrated and described above), such that the temperature sensor 198 is configured to receive inputs and outputs from the controller 130.

In some embodiments, the measured temperature may be used by the controller 130 to maintain the biological cartridge within a predetermined temperature range. That is, the controller 130 may control the heating element 160 in response to the temperature measured by the temperature sensor 198.

In some embodiments, the predetermined temperature range may be between 30° C. and 37° C. In further embodiments, any other suitable temperature range may be used, including but not limited to between 25° C. and 40° C., between 20° C. and 50° C., or any other suitable temperature range.

By measuring the temperature of the heating element 160 and through experimentation and calculations, such as of the heat transfer properties of heat spreader 170 and the biological cartridge 190, the temperature of the biological sample may be able to be maintained without directly measuring the temperature of the biological sample.

The temperature sensor 198 may be any suitable type of sensor which may be used to detect the temperature of the heating element, including but not limited to a thermistor, a resistance temperature detector, a thermocouple, or any other suitable type of temperature sensor.

In some embodiments, the temperature sensor 198 may be coupled to other elements of the microscope assembly 100, including but not limited to being coupled to the biological cartridge 190 or being coupled to the heat spreader 170.

In some embodiments, the biological sample may be captured in other types of devices, such as a flat microscope slide. In such embodiments, the stage 140, heat spreader 170, and heating element 160 may be configured to secure and heat the flat microscope slide.

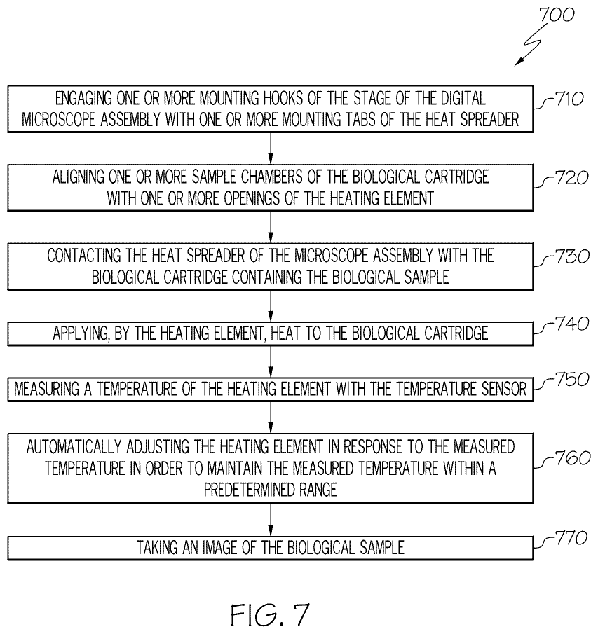

Referring now to FIG. 7, an illustration of a method 700 is illustrated with reference to FIGS. 1-6 consistent with a disclosed embodiment. The method 700 is directed at calibrating biological analysis devices. At step 710, the method 700 includes engaging one or more mounting hooks 150 of the stage 140 of the digital microscope assembly 100 with one or more mounting tabs 178 of the heat spreader 170. That is, heat spreader 170 may be coupled to the stage 140, which may allow the image detector 116 to image the biological sample held within the biological cartridge 190 which is coupled to the heat spreader 170.

At step 720, the method 700 includes aligning one or more sample chambers 196 of the biological cartridge 190 with one or more openings 164 of the heating element 160. That is, each of the one or more sample chambers 196 may slide through each of the one or more openings 164 of the heating element 160.

At step 730, the method 700 includes contacting the heat spreader 170 of the microscope assembly 100 with the biological cartridge 190 containing the biological sample. The biological cartridge 190 directly contacts the heat spreader 170 and the heat spreader 170 directly contacts the heating element 160 to allow for thermal transfer from the heating element 160 to the heat spreader 170 and to the biological cartridge 190.

At step 740, the method 700 includes applying, by the heating element 160, heat to the biological cartridge 190. That is, the heating element 160 may be activated by the controller 130 through any suitable activation means, and this may apply heat to the biological cartridge 190, such as through the heat spreader 170.

At step 750, the method 700 includes measuring a temperature of the heating element 160 with the temperature sensor 198. That is, the temperature sensor 198 may be coupled to the heating element 160 and be configured to measure the temperature of the heating element 160.

At step 760, the method 700 includes automatically adjusting the heating element 160 in response to the measured temperature in order to maintain the measured temperature within a predetermined range. That is, the controller 130 may be configured to receive the measured temperature from the temperature sensor 198 and modify a signal to the heating element 160 in response. As a non-limiting example, if the measured temperature is at the bottom of the predetermined range, the controller 130 may increase the heat from the heating element 160, and if the measured temperature is at the top of the predetermined range, the controller 130 may decrease the heat from the heating element 160.

At step 770, the method 700 includes taking an image of the biological sample. That is, the image detector 116 may capture an image of the biological sample captured within the biological cartridge 190.

It may be noted that one or more of the following claims utilize the terms “where,” “wherein,” or “in which” as transitional phrases. For the purposes of defining the present technology, it may be noted that these terms are introduced in the claims as an open-ended transitional phrase that are used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Further aspects of the embodiments described herein are provided by the subject matter of the following clauses:

A digital microscope assembly comprising: a stage for receiving a biological cartridge holding a biological sample, the biological cartridge having a top face, a bottom face, and defining a sample chamber that at least partially encapsulates the biological sample; an image detector in optical communication with the stage; a controller communicatively coupled to the image detector; and a heating element communicatively coupled to the controller, wherein the heating element defines a perimeter surrounding the sample chamber of the biological cartridge with the biological cartridge positioned on the stage.

The digital microscope assembly of any preceding clause, wherein the heating element defines a pair of perimeters, and wherein a first perimeter of the pair of perimeters surrounds a first sample chamber of the biological cartridge and a second perimeter of the pair of perimeters surrounds a second sample chamber of the biological cartridge.

The digital microscope assembly of any preceding clause, wherein the stage comprises one or more mounting hooks.

The digital microscope assembly of any preceding clause, further comprising a heat spreader thermally coupled to the heating element, the heat spreader including a top face, a bottom face, and one or more mounting tabs.

The digital microscope assembly of any preceding clause, wherein: the top face of the heat spreader is structurally configured to directly contact the bottom face of the biological cartridge on the stage; and the heating element is directly in contact with the bottom face of the heat spreader.

The digital microscope assembly of any preceding clause, wherein the one or more mounting hooks apply force to the heat spreader and the biological cartridge relative to the stage.

The digital microscope assembly of any preceding clause, wherein: the heat spreader defines at least one opening surrounding at least one sample chamber protruding from the bottom face of the biological cartridge.

The digital microscope assembly of any preceding clause, wherein the at least one opening of the heat spreader comprises an inwardly tapered sidewall moving from the top face of the heat spreader to the bottom face of the heat spreader.

The digital microscope assembly of any preceding clause, wherein the heat spreader defines a pair of openings, wherein: a first opening of the pair of openings surrounds a first sample chamber of the biological cartridge; and a second opening of the pair of openings surrounds a second sample chamber of the biological cartridge.

The digital microscope assembly of any preceding clause, wherein the heat spreader comprises a septum separating the first opening and the second opening.

The digital microscope assembly of any preceding clause, wherein the septum defines a septum axis, and the heat spreader is symmetric about the septum axis.

The digital microscope assembly of any preceding clause, wherein the one or more mounting tabs of the heat spreader are configured to pivot about the one or more mounting hooks of the stage.

The digital microscope assembly of any preceding clause, further comprising: a temperature sensor communicatively coupled to the controller, wherein the temperature sensor detects a temperature of the heating element.

The digital microscope assembly of any preceding clause, wherein the temperature sensor is coupled to the heating element.

The digital microscope assembly of any preceding clause, wherein the controller comprises a processor configured to automatically adjust an output of the heating element in response to an input from the temperature sensor.

A method for heating a biological cartridge of a digital microscope assembly, the method comprising the steps of: contacting a heat spreader of the digital microscope assembly with a biological cartridge containing a biological sample, the biological cartridge directly contacting the heat spreader and the heat spreader directly contacting a heating element; applying, by the heating element, heat to the biological cartridge; measuring a temperature of the heating element with a temperature sensor; automatically adjusting the heating element in response to the measured temperature; and taking an image of the biological sample.

The method of any preceding clause, wherein the step of automatically adjusting the heating element in response to the measured temperature further comprises maintaining the measured temperature within a predetermined range after the heating element is automatically adjusted.

The method of any preceding clause, wherein contacting the heat spreader comprises engaging one or more mounting hooks of a stage of the digital microscope assembly with one or more mounting tabs of the heat spreader.

The method of any preceding clause, further comprising aligning a sample chamber of the biological cartridge with an opening defined by the heating element.

The method of any preceding clause, wherein contacting the heat spreader further comprising aligning a pair of sample chambers of the biological cartridge with a pair of openings defined by the heating element.

Having described the subject matter of the present disclosure in detail and by reference to specific embodiments, it may be noted that the various details described in this disclosure should not be taken to imply that these details relate to elements that are essential components of the various embodiments described in this disclosure, even in casings where a particular element may be illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

What is claimed is:

1. A digital microscope assembly comprising:
a stage for receiving a biological cartridge holding a biological sample, the biological cartridge having a top face, a bottom face, and defining a sample chamber that at least partially encapsulates the biological sample;
an image detector in optical communication with the stage;
a controller communicatively coupled to the image detector; and
a heating element communicatively coupled to the controller, wherein the heating element defines a perimeter surrounding the sample chamber of the biological cartridge with the biological cartridge positioned on the stage.

2. The digital microscope assembly of claim 1, wherein the heating element defines a pair of perimeters, and wherein a first perimeter of the pair of perimeters surrounds a first sample chamber of the biological cartridge and a second perimeter of the pair of perimeters surrounds a second sample chamber of the biological cartridge.

3. The digital microscope assembly of claim 1, wherein the stage comprises one or more mounting hooks.

4. The digital microscope assembly of claim 1, further comprising a heat spreader thermally coupled to the heating element, the heat spreader including a top face, a bottom face, and one or more mounting tabs.

5. The digital microscope assembly of claim 4, wherein:
the top face of the heat spreader is structurally configured to directly contact the bottom face of the biological cartridge on the stage; and
the heating element is directly in contact with the bottom face of the heat spreader.

6. The digital microscope assembly of claim 5, wherein the one or more mounting hooks apply force to the heat spreader and the biological cartridge relative to the stage.

7. The digital microscope assembly of claim 5, wherein:
the heat spreader defines at least one opening surrounding at least one sample chamber protruding from the bottom face of the biological cartridge.

8. The digital microscope assembly of claim 7, wherein the at least one opening of the heat spreader comprises an inwardly tapered sidewall moving from the top face of the heat spreader to the bottom face of the heat spreader.

9. The digital microscope assembly of claim 5, wherein
the heat spreader defines a pair of openings, wherein:
a first opening of the pair of openings surrounds a first sample chamber of the biological cartridge; and
a second opening of the pair of openings surrounds a second sample chamber of the biological cartridge.

10. The digital microscope assembly of claim 9, wherein the heat spreader comprises a septum separating the first opening and the second opening.

11. The digital microscope assembly of claim 10, wherein the septum defines a septum axis, and the heat spreader is symmetric about the septum axis.

12. The digital microscope assembly of claim 5, wherein the one or more mounting tabs of the heat spreader are configured to pivot about the one or more mounting hooks of the stage.

13. The digital microscope assembly of claim 1, further comprising:
a temperature sensor communicatively coupled to the controller, wherein the temperature sensor detects a temperature of the heating element.

14. The digital microscope assembly of claim 13, wherein the temperature sensor is coupled to the heating element.

15. The digital microscope assembly of claim 11, wherein the controller comprises a processor configured to automatically adjust an output of the heating element in response to an input from the temperature sensor.

16. A method for heating a biological cartridge of a digital microscope assembly, the method comprising the steps of:
contacting a heat spreader of the digital microscope assembly with a biological cartridge containing a biological sample, the biological cartridge directly contacting the heat spreader and the heat spreader directly contacting a heating element;
applying, by the heating element, heat to the biological cartridge;
measuring a temperature of the heating element with a temperature sensor;
automatically adjusting the heating element in response to the measured temperature; and
taking an image of the biological sample.

17. The method of claim 16, wherein the step of automatically adjusting the heating element in response to the measured temperature further comprises maintaining the measured temperature within a predetermined range after the heating element is automatically adjusted.

18. The method of claim 16, wherein contacting the heat spreader comprises engaging one or more mounting hooks of a stage of the digital microscope assembly with one or more mounting tabs of the heat spreader.

19. The method of claim 16, further comprising aligning a sample chamber of the biological cartridge with an opening defined by the heating element.

20. The method of claim 16, wherein contacting the heat spreader further comprising aligning a pair of sample chambers of the biological cartridge with a pair of openings defined by the heating element.
